(19) United States
(12) Patent Application Publication
(10) Pub. No.: US 2015/0367259 A1
(43) Pub. Date: Dec. 24, 2015

(54) Gravity Induced Separation Of Gases And Fluids In A Vacuum-Based Drilling Fluid Recovery System

(71) Applicant: FP Marangoni Inc., Calgary (CA)

(72) Inventors: Alan Robert Imler, Calgary (CA); Derek Joseph Lowe, Calgary (CA)

(21) Appl. No.: 14/744,542

(22) Filed: Jun. 19, 2015

Related U.S. Application Data
(60) Provisional application No. 62/034,309, filed on Aug. 7, 2014.
(60) Provisional application No. 62/014,781, filed on Jun. 20, 2014.

(51) Int. Cl. B01D 29/60; B01D 29/50; B01D 36/00; B01D 29/085

(52) U.S. Cl. CPC B01D 29/605; B01D 23/28; B01D 29/50; B01D 36/00

(57) ABSTRACT

A system for recovering used drilling fluid from drill cuttings being processed on a shaker screen. The system includes: a vacuum screen attachment operatively connected to the underside of the shaker screen, the vacuum screen attachment operatively connected to a vacuum source by a vacuum conduit; a hydrostatic chamber located in the vacuum conduit downstream of the vacuum screen attachment, the hydrostatic chamber having a fluid dump port at or adjacent to its bottom surface; a means for setting a limit of fluid accumulation in the hydrostatic chamber, wherein fluid dumps from the fluid dump port when the limit of fluid accumulation is reached; and a conduit for conveying the fluid dumped from the fluid dump port to a storage tank.

### CROSS-REFERENCE TO RELATED APPLICATIONS

This application claims priority from U.S. Provisional Application Ser. No. 62/014,781 filed on Jun. 20, 2014, and U.S. Provisional Application Ser. No. 62/034,309 filed on Aug. 7, 2014, the entire disclosures of which are incorporated herein by reference.

### FIELD OF THE INVENTION

The invention relates to systems and methods for recovering used drilling fluids from drill cuttings generated by oil and gas drilling operations.

### BACKGROUND OF THE INVENTION

The loss of drilling fluids presents several technological and cost challenges to the energy exploration industry. These challenges generally include the seepage losses of drilling fluids to the formation, the recovery of drilling fluids at surface and/or the disposal of drilling detritus or cuttings that are contaminated with drilling fluid. In the context of this description, “drilling fluid” is both fluid prepared at surface used in an unaltered state for drilling as well as all fluids recovered from a well that may include various contaminants from the well including water and hydrocarbons (both liquid and gas

As is known, and by way of background, during the excavation or drilling process, drilling fluid losses can reach levels approaching 300 cubic meters of lost drilling fluid over the course of a drilling program. With some drilling fluids having values in excess of $1600 per cubic meter, the loss of such volumes of fluids represents a substantial cost to drill operators.

Drilling fluids are generally characterized as either “water-based” or “oil-based” drilling fluids that may include many expensive and specialized chemicals as known to those skilled in the art. As a result, it is desirable that minimal quantities of drilling fluids are lost during a drilling program such that many technologies have been considered and/or employed to minimize drilling fluid losses both downhole and at surface.

Additionally, in some areas the delivery of oil or water for the formulation of drilling fluids can present several costly challenges for some operations; specifically desert, offshore and even some districts where communities will not allow allocation of water for this use.

As noted above, one particular problem is the separation of drilling fluid and any hydrocarbons from the formation that may be adhered to the drill cuttings (collectively “fluids”) at the surface. The effective separation of various fluids from drill cuttings has been achieved by various technologies including but not limited to; hydrocyclones, mud cleaners, linear motion shakers, scroll centrifuges, vertical basket centrifuges (VBC), vacuum devices, and vortex separators. As known to those skilled in the art, these devices are typically rented by operators at costs ranging from $1000 to $2000 per day and, as a result, can also represent a significant cost to operators. Thus, the recovery of fluids necessary to recover these costs generally requires that the recovered fluid value is greater than the equipment rental cost in order for the recovery technology to be economically justified. On excavation projects where large amounts of high-cost drilling fluid are being lost (for example in excess of 3 cubic meters per day), then daily rental charges for specialized separation equipment can provide favorable economics. In addition, an operator will likely also factor in the environmental effects and/or costs of disposal of drilling fluid contaminated drill cuttings in designing their drilling fluids/drill cutting separation/recovery systems.

Further still, past techniques for separating drilling fluid from drill cuttings have also used liquid spraying systems to deliver “washing” liquids to drill cuttings as they are processed over shaker equipment. Such washing liquids and associated fluid supply systems are used to deliver various washing fluids as the cuttings are processed over a shaker and can include a wide variety of designs to deliver different washing fluids depending on the type of drilling fluid being processed. For example, washing liquids may be comprised of oil, water, or glycol depending on the drilling fluid and drill cuttings being processed over the shaker. Generally, these washing fluids are applied to reduce the viscosity and/or surface tension of the fluids adhered to the cuttings and allow for more fluids to be recovered. However, these techniques have generally been unable to be cost effective for many drilling fluids as the use of diluting fluids often produces unacceptable increases in drilling fluid volume and/or changes in chemical consistency and, hence, rheological properties of the drilling fluid.

Thus, while various separation systems are often effective and/or efficient in achieving a certain level of fluids/cuttings separations, each form of separation technology can generally only be efficiently operated within a certain range of conditions or parameters and at particular price points. For example, standard shakers utilizing screens are relatively efficient and consistent in removing a certain amount of drilling fluid from cuttings where, during the typical operation of a shaker, an operator will generally be able to effect drilling fluid/cuttings separation to a level of about 12-40% by weight of fluids relative to the drill cuttings (i.e. 12-40% of the total mass of recovered cuttings is drilling fluid). The range of fluids/cuttings wt % is generally controlled by screen size wherein an operator can effect a higher degree of fluids/cuttings separation by using a larger screen opening (eg. 50-75 mesh) and a lower degree of fluids/cuttings separation with a smaller screen opening (eg. up to 325 mesh), The trade-off between using a large mesh screen vs. a small mesh screen is the effect of mesh screen size on the quantity of solids passing through the screen and the time required to effect that separation. That is, while an operator may be able to lower the fluids retained on cuttings coming off the shaker with a larger mesh screen (50-75 mesh), the problem with a larger mesh screen is that substantially greater quantities of solids will pass through the screen, that then significantly affect the rheology and density of the recovered fluids and/or require the use of an additional and potentially less efficient separation technology to remove those solids from the recovered drilling fluids. Conversely, using a small mesh screen, while potentially minimizing the need for further downstream separation techniques to remove solids from recovered drilling fluids, results in substantially larger volumes of drilling fluids not being recovered, as they are more likely to pass over the screens hence leading to increased drilling fluids losses and/or require subsequent processing.

Accordingly, in many operations, an operator will condition fluid recovered from a shaker to additional processing with a centrifugal force type device in order to reduce the fluid density and remove as much of the fine solids as possible before re-cycling or reclaiming the drilling fluid. However, such conditioning requires more expensive equipment such as centrifuges, scrolling centrifuges, hydrocyclones, etc., which then contribute to the overall cost of recovery. These processing techniques are also directly affected by the quality of the fluid they are processing, so fluids pre-processed by shakers using a coarse screen will not be as optimized as those received from finer screens.

Furthermore, the performance of centrifuges and hydrocyclones and other equipment are directly affected by the viscosity and density of the feed fluid. As a result, drilling fluid recovery techniques that send heavy, solids-laden fluids to secondary processing equipment require more aggressive techniques such as increased g-forces and/or vacuum to effect separation which will typically cause degradation in the drill cuttings.

Further still, such secondary processing equipment typically cannot process drill cuttings and drilling fluids at the same throughput values of a shaker with the result being that additional separation equipment may be required or storage tanks may be required to temporarily hold accumulated drilling fluid.

Thus, the operator will try to balance the cost of drilling fluid losses with the quality of the fluid that is recovered together with other considerations. While operators will typically have little choice in the quality of the cuttings processing and fluid recovery techniques available, many operators will operate separation equipment such that the recovered drilling fluid density from the separation equipment will be about 200-300 kg/m³ heavier than the density of the circulating fluid in the system. This heavier fluid which would contain significant quantities of fine solids and that when left in the drilling fluid will either immediately or over time impair the performance of the drilling fluid or any other type of fluid.

As a result, there continues to be a need for systems that economically increase the volume of fluids recovered from a shaker without negatively impacting the rheological properties of the recovered drilling fluid.

In addition, there has been a need to develop low-cost retrofit technologies that can enhance fluid recovery and do so at a fractional cost level to mechanisms and technologies currently employed. Further, there has been a need for retro-fit technologies that can be utilized on a variety of shakers from different manufactures and that can be used to enhance the operation of existing shakers.

The use of vacuum technology has been one solution to improving the separation of drilling fluids. However, vacuum technologies may also present dust and mist problems in the workplace. With past vacuum techniques there is a need to regularly clean clogged screens with high pressure washes. High pressure washing of screens creates airborne dust and mist hazards to operators. Thus, there continues to be a need for technologies that minimize the requirement for screen washing.

Further still, there has been a need for improved fluid separation systems on the underside of a vacuum screen that allows relatively large volumes of air to be drawn through a vacuum screen to be effectively and efficiently separated from the relatively low volume of drilling fluid being drawn through a vacuum screen. That is, there has been a need for improved fluid/air separation systems.

Further still, there has been a need for retrofit systems that can be adapted to standard shakers without substantial modification to the existing shaking and that allow for quick and easy installation at a job site. In addition, there has been a need for retrofit systems that also allow for ready disassembly of the system for transport and/or maintenance.

As is known, the entry of gas from a formation into circulating drill fluid occurs regularly during drilling operations where pressurized gasses from the formation mix with the circulating drilling fluid and dissolve within the drilling fluid which depending on the quantity and pressures may fully saturate the drilling fluid. This is particularly true as a drill bit enters a pay-zone within the formation and there is an influx of formation gas into the well bore which will lead to a saturation of drilling fluid with the formation gas. As the drilling fluid rises to the surface and is depressurized, gas may be released from the drilling fluid.

As a result, there has also been a need for systems that improve the ability of shaker systems to improve gas/fluid separation at a shaker. Currently used systems typically include a vacuum conduit running from the shaker screen connection to a large recovery tank which is in line with a powerful vacuum system. According to normal operations, the vacuum systems run continuously until the large tanks become filled with recovered drilling fluid, at which point the recovered drilling fluid is pumped out of the recovery tank and conveyed to the main drilling fluid supply vessels which are known as “mud tanks.” Improved systems which reduce the complexity of fluid transfer and related energy requirements are desirable.

Various technologies including vacuum technologies have been used in the past for separating drilling fluids from drill cuttings including vibratory shakers.

For example, U.S. Pat. No. 4,350,591 describes a drilling mud cleaning apparatus having an inclined travelling belt screen and degassing apparatus including a hood and blower. U.S. Patent Publication No. 2008/0078700 discloses a self-cleaning vibratory shaker having retro-fit spray nozzles for cleaning the screens. Canadian Patent Application No. 2,664,173 describes a shaker with a pressure differential system that applies a non-continuous pressure across the screen. U.S. Pat. No. 4,639,258 and U.S. Patent Publication Nos. 2014/0110357, 2014/0091028 and 2013/0074360 describe vacuum-assisted shale shakers. U.S. Pat. No. 8,691,097 describes a separating tower with a top vacuum discharge port and a bottom solids discharge port. Other references including U.S. Pat. No. 6,092,390, U.S. Pat. No. 6,170,580, U.S. Patent Publication 2006/0113220 and PCT Publication No. 2005/054623 describe various other separation technologies. Each of the above-noted references is incorporated herein by reference in entirety.

Thus, while past technologies may be effective to a certain degree in enabling drilling fluid/cuttings separation, the prior art is silent in aspects of the design and operation of alternative separation devices that enable expedient conveyance of the collected drilling fluid in a convenient and cost-effective manner with minimal equipment requirements.

### SUMMARY OF THE INVENTION

In accordance with one aspect of the present invention, there is provided a system for recovering used drilling fluid from drill cuttings being processed on a shaker screen, the system comprising: a vacuum screen attachment operatively connected to the underside of the shaker screen, the vacuum screen attachment operatively connected to a vacuum source by a vacuum conduit; a hydrostatic chamber located in the vacuum conduit downstream of the vacuum screen attachment, the hydrostatic chamber having a fluid dump port at or adjacent to its bottom surface; a means for setting a limit of fluid accumulation in the hydrostatic chamber, wherein fluid dumps from the fluid dump port when the limit of fluid accumulation is reached; and a conduit for conveying the fluid dumped from the fluid dump port to a storage tank.

In certain embodiments, the means for setting the limit of fluid accumulation comprises: one or more fluid level sensors configured to identify one or more specific levels of fluid inside the hydrostatic chamber; a vacuum controller for running and shutting off the vacuum source, the controller in communication with the sensors and configured to stop the vacuum source when one of the one or more specific levels of fluid is reached; and a valve connected to the fluid dump port and configured to prevent dumping of fluid from the fluid dump port when the vacuum source is running and further configured to allow dumping of fluid when the vacuum source is shut off.

In certain embodiments, the sensors include a first fluid level sensor and a second fluid level sensor, each located within the hydrostatic chamber, wherein the first fluid level sensor. is located above the second fluid level sensor.

In certain embodiments, the valve is a passive flapper valve.

In certain embodiments, the system further comprises a float valve in the hydrostatic chamber above the first fluid level sensor, the float valve configured to shut off the vacuum source if either or both of the sensors fail and fluid reaches and activates the float valve.

In certain embodiments, the system further includes a fluid separator located in the vacuum conduit between the hydrostatic chamber and the vacuum source, the fluid separator provided to prevent entry of fluid into the vacuum source.

In certain embodiments, the fluid separator is a cyclone separator provided with a lower port for exit of waste fluid collected therein.

In certain embodiments, the system further includes one or more filters located in the vacuum conduit between the fluid separator and the vacuum source.

In certain embodiments, the hydrostatic chamber is cylindrical.

In certain embodiments, the vacuum source is connected to the hydrostatic chamber at the top of the hydrostatic chamber.

In certain embodiments, the vacuum source is a regenerative fan blower.

In certain embodiments, the means for setting the limit of fluid accumulation in the hydrostatic chamber is provided by a vacuum equalization tube having a first connection to the interior of the hydrostatic chamber at or adjacent to the bottom of the hydrostatic chamber and a second connection to the interior of the hydrostatic chamber located above the first connection, wherein the fluid dump port allows entry of air into the hydrostatic chamber and into the vacuum equalization tube under force of the vacuum source and allows exit of fluid from the hydrostatic chamber and vacuum equalization tube induced by a reduction of vacuum force at the fluid dump port produced by the vacuum equalization tube and by the force of gravity acting on the hydrostatic head of the fluid in the hydrostatic chamber when the force of gravity on the hydrostatic head exceeds the force of air entering the system through the fluid dump port.

In certain embodiments, the system further includes a second fluid dump port located in the vacuum conduit either upstream or downstream from the hydrostatic chamber.

In certain embodiments, the second fluid dump port is located in the vacuum conduit between the vacuum screen attachment and the hydrostatic chamber, wherein the second fluid dump port allows entry of air into the vacuum conduit under force of the vacuum source and exit of fluid from the vacuum conduit through the second fluid dump port induced by the force of gravity acting on the weight of the fluid above the second fluid dump port.

In certain embodiments, the second fluid dump port is located in a conduit connector unit, the connector unit having a connection to at least one vacuum screen attachment and a connection to the vacuum source.

In certain embodiments, the conduit connector Unit comprises two or more connections to two or more vacuum screen attachments.

In certain embodiments, the second fluid dump port is provided with a choke mechanism for reducing the pressure of the air flow into the vacuum conduit under force provided by the vacuum source.

In certain embodiments, the second connection of the vacuum equalization tube to the hydrostatic chamber is located adjacent the top of the hydrostatic chamber.

In certain embodiments, the hydrostatic chamber is cylindrical.

In certain embodiments, the inner sidewall of the hydrostatic chamber is provided with a series of downwardly angled baffles to provide resistance to upward movement of fluids under the force of vacuum from the vacuum source.

In certain embodiments, the vacuum source is connected to the hydrostatic chamber at the top of the hydrostatic chamber.

In certain embodiments, the system further includes a fluid separator located in the vacuum conduit between the hydrostatic chamber and the vacuum source, the fluid separator provided to prevent entry of fluid into the vacuum source.

In certain embodiments, the system further includes a shut-off switch attached at an intermediate vertical position of the inner sidewall of the liquid separator, the shut-off switch for shutting off the vacuum source when the fluid level inside the fluid separator reaches the level of the shut-off switch.

In certain embodiments, the system further includes a third fluid dump port located in the vacuum conduit downstream of the liquid separator, the third fluid dump port configured to dump fluid accumulating in the liquid separator when the shut-off switch is engaged and the vacuum system is shut off.

In certain embodiments, the system further includes a vent valve located in the vacuum conduit between the hydrostatic chamber and the liquid separator.

In certain embodiments, the system further includes a shut-off switch in electronic communication with the vacuum source and automatically programmed to shut off the vacuum source at pre-determined intervals for a pre-determined period of time for the purpose of displacing the drill cuttings from the shaker screen by compensating reflexive motion of the shaker screen.

In certain embodiments, the vacuum source is a regenerative fan blower.

Another aspect of the present invention is a method for recovering used drilling fluid from drill cuttings being processed on a shaker screen, the method comprising the steps of: connecting a vacuum source to the underside of the shaker screen with a vacuum screen attachment, the vacuum source providing vacuum force to the underside of the shaker screen; installing a hydrostatic chamber in the vacuum conduit between the vacuum screen attachment and the vacuum source; providing a fluid dump port and valve in fluid communication with the hydrostatic chamber, the fluid dump port and valve allowing exit of fluid from the hydrostatic chamber induced by a reduction of vacuum force within the hydrostatic chamber and by the force of gravity acting on the hydrostatic head of the fluid in the hydrostatic chamber when the vacuum force is reduced; and activating the vacuum source until a pre-determined level of fluid is contained in the hydrostatic chamber, wherein the pre-determined level of fluid causes the fluid to drain from the fluid dump port.

In certain embodiments, the pre-determined level of fluid is identified by a sensor.

In certain embodiments, the identification of the pre-determined level of fluid by the sensor shuts off the vacuum source.

In certain embodiments, the pre-determined level of fluid is reached when the force of gravity acting on the hydrostatic head of the fluid exceeds the force of air entering the fluid dump port under vacuum provided by the vacuum source.

In certain embodiments, the method further includes providing a second fluid dump port in the vacuum conduit either upstream or downstream from the hydrostatic chamber and recovering the fluid dumping from the second fluid dump port.

In certain embodiments, the second fluid dump port is located in the vacuum conduit between the vacuum screen attachment and the hydrostatic chamber, the second fluid dump port allowing entry of air into the vacuum conduit under force of the vacuum source and exit of fluid from the vacuum conduit through the second fluid dump port induced by the force of gravity acting on the weight of the fluid above the second fluid dump port.

In certain embodiments, the second fluid dump port is located in a conduit connector unit, the connector unit having a connection to at least one vacuum screen attachment and a connection to the vacuum source.

In certain embodiments, the conduit connector unit comprises two Cr more connections to two or more vacuum screen attachments.

In certain embodiments, the second fluid dump port is provided with a choke mechanism for reducing the pressure of the air flow into the vacuum conduit under force provided by the vacuum source.

In certain embodiments, the inner sidewall of the hydrostatic chamber is provided with a series of downwardly angled baffles to provide resistance to upward movement of fluids under the force of vacuum from the vacuum source.

In certain embodiments, the vacuum source is connected to the hydrostatic chamber at the top of the hydrostatic chamber.

In certain embodiments, a fluid separator is provided in the vacuum conduit between the hydrostatic chamber and the vacuum source, the fluid separator provided to prevent entry of fluid into the vacuum source.

In certain embodiments, the vacuum source is a regenerative fan blower.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale. Instead, emphasis is placed upon illustrating the principles of various embodiments of the invention. Similar reference numerals indicate similar components.

FIG. 1A is a plan view of a platform supporting a vacuum system and drilling fluid recovery tank as currently used in the prior art.

FIG. 1B is a perspective view of the same platform shown in FIG. 1A.

FIG. 2 is a schematic view of a system for recovering drilling fluid according to one embodiment of the present invention.

FIG. 3 is a schematic view of a system for recovering drilling fluid according to another embodiment of the present invention.

FIG. 4 is a schematic view of a system for recovering drilling fluid according to another embodiment of the present invention.

### DETAILED DESCRIPTION OF THE INVENTION

### Rationale

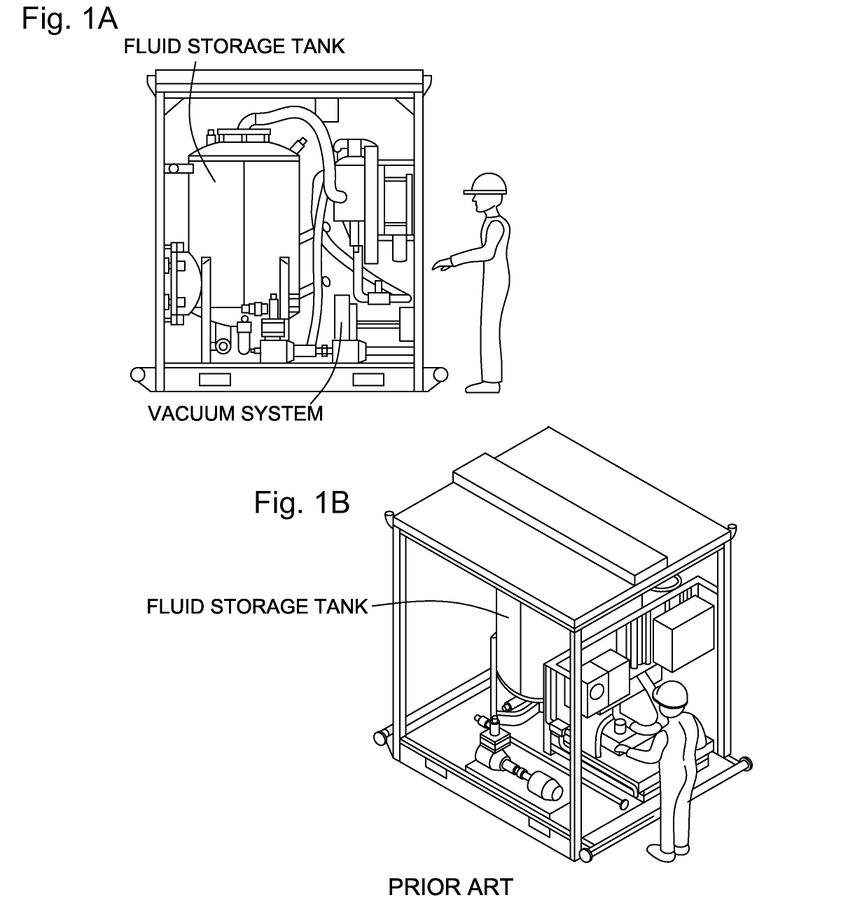

As noted in the background section, presently used vacuum-enhanced shaker systems connect to the underside of the screens of the shakers and apply vacuum to the underside of a portion of the screen. The fluids recovered from these systems are typically conveyed to a large holding tank which is in-line with the vacuum pump. The tank fills with recovered drilling fluid after the vacuum pump pulls the fluid from the cuttings on the screen and conveys it to the tank. When the tank is full of fluid recovered from the cuttings on the shaker screens, the fluid is pumped to the main drilling fluid supply tanks (which are known in the art as “mud tanks”) to contribute to the supply of drilling fluid used to drill the well. A representative prior art vacuum and tank system is shown in FIG. 1. It is seen that the vacuum tank and vacuum system are supported by a large frame which represents a significant footprint at a drilling site. Representative characteristics of a typical tank and vacuum system include the following: tank volume 1.12 m³, horsepower of vacuum motor 25 HP, maximum pump rate 325 CFM (cubic feet per minute), total weight of tank and vacuum system 5300 lbs, footprint 8.5 feet×6.5 feet, height 8.75 feet, power rating to operate: 480 volts AC, 60 amps. The approximate retail cost of producing a typical vacuum and tank unit is $50,000 (CAD) and these units will be typically rented by drilling operators at a cost of $750 to $1000 (CAD) per day. These units incur significant shipping and delivery costs due to their weight and size.

The inventors have surprisingly discovered that providing a vacuum-based fluid recovery system with the capability to control the balance between the force of air influx into the vacuum conduit and the force of gravity acting on fluid within the vacuum conduit provides a means for dumping and recovery of drilling fluid at one or more dump ports. Additionally, the force of gravity can be used to dump drilling fluid under control of a fluid sensor. When such dump ports are provided at locations relatively close to the shaker screens, fluid can be dumped (and recovered) from the vacuum conduit at an early stage, thereby reducing the vacuum force required to move the drilling fluid over a longer distance, as required in prior art tank systems. As a result, a less powerful vacuum system may be employed, thereby reducing equipment costs, energy requirements and footprint. In certain embodiments discussed in detail below, the power requirements are reduced by about 90%. In addition, dumping of fluid directly to a conduit connected to the mud tanks obviates the need for the large intermediate fluid storage tank. As a result, the present invention thus provides a simpler and significantly less costly alternative to the prior art tank and vacuum system.

It is currently estimated that the components of the system provided according to certain aspects of the invention weigh as little as about 200 lbs and have a much smaller footprint as well as being of simple construction, thereby significantly simplifying efforts relating to maintenance and repairs. It may be possible to deliver components of the present system to drilling sites via aircraft and/or light-duty vehicles instead of using large transport trucks. It may also be possible to deliver the components of the system to drilling sites by a commercial courier service. This provides a significant advantage in terms of deployment costs. It is also expected that the simplicity of the system will allow it to be easily integrated with existing equipment at essentially any drilling site where recovery of drilling fluids is desired.

### DESCRIPTION OF EXAMPLE EMBODIMENTS

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### Example 1

### Drill Fluid Recovery System with Primary Fluid Recovery Driven by a Hydrostatic Chamber

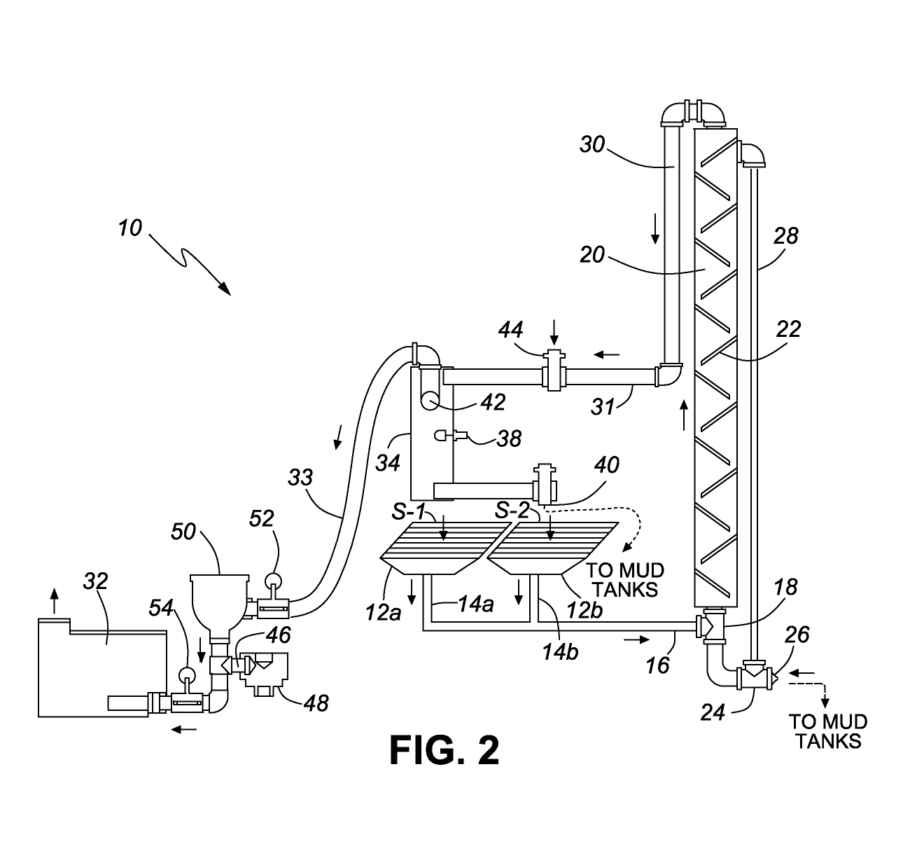

Referring now to FIG. 2, there is shown a system 10 according to one embodiment of the present invention. System 10 is shown connected to two shaker screens S-1 and S-2. Alternative embodiments include only a single connection to a single screen or more than two connections to more than two screens. These alternatives are within the scope of the invention. The connections to the screens S-1 and S-2 are made with vacuum screen attachments 12a and 12b which are often referred to in the art as “manifolds” or “vacuum manifolds.” The function of these components is to convey downward vacuum force against the fluid-contaminated drill cuttings on the screens S-1 and S-2, thereby removing the fluid from the cuttings which continue to vibrate on the shaker as they are conveyed off the screens S-1 and S-2. Vacuum screen attachments 12a and 12b are connected to respective vacuum conduits 14a and 14b which join a common conduit 16 that leads directly to a T-junction connector 18 connected to the bottom of a hydrostatic chamber 20. In this particular embodiment, the interior sidewall of the hydrostatic chamber 20 is provided with a series of downwardly angled baffles 22 to interrupt the upward flow of fluid under vacuum force. Alternative means for interrupting the upward flow of fluid under vacuum source may be provided in the hydrostatic chamber 20 instead of the baffles 22 and embodiments of the system 10 which incorporate such alternatives are within the scope of the present invention.

In this particular embodiment, the upper end of the T-junction connector 18 is attached to an opening in the bottom of the hydrostatic chamber 20 and the lower end of the T-junction connector 18 is connected to a short length of conduit which leads to a second T junction connector 24. This second T-junction connector 24 is in communication with fluid dump port 26. The upper opening in the second T-junction connector 24 is connected to a vacuum equalization tube 28 which is provided in order to reduce the vacuum force in the immediate vicinity of fluid dump port 26. It is this reduction in vacuum force near fluid dump port 26 that allows the force of air entering the system 10 through fluid dump port 26 to be overcome when the counteracting force of gravity acting on the hydrostatic head of fluid collecting in the hydrostatic chamber 20 becomes greater than the force of air entering the system 10 under vacuum. When this condition is met, fluid will dump from fluid dump port 26 (as described in more detail hereinbelow). In alternative embodiments, the T-junction connector is attached to the sidewall of the hydrostatic chamber 20 adjacent to the bottom of the hydrostatic chamber 20 instead of the bottom of the hydrostatic chamber 20.

In the embodiment of FIG. 2, the interior of the vacuum equalization tube 28 is connected with the interior of the hydrostatic chamber 20 near the top of the hydrostatic chamber 20. An additional section 30 of vacuum conduit leads out of the hydrostatic chamber 20 at the top and is routed to the vacuum source which in this particular embodiment is provided by a regenerative fan blower 32. The skilled person will recognize that alternative vacuum sources may be used and systems include such alternatives are also within the scope of the present invention. The regenerative fan blower 32 of this particular embodiment provides a number of advantages over the vacuum sources used in the prior art, most notably it is less expensive because its power rating is about 10% of the prior art vacuum sources used in conjunction with large fluid recovery tanks such as shown in FIGS. 1A and 1B. For example, in certain embodiments, the system 10 employs a regenerative fan blower 32 which is power rated for 3 HP. In contrast prior art vacuum pump systems (such as the vacuum pump shown in FIG. 1) used for similar purposes require power ratings about 10-fold higher (25 to 30 HP). In addition, a regenerative fan blower 32 generally requires maintenance on a significantly less frequent basis than the vacuum pumps currently in use.

In the embodiment shown in FIG. 2, an optional fluid trap is provided by a fluid separator 34 whose function is to ensure that fluid does not move further downstream and enter the regenerative fan blower 32. Examples of fluid separators are produced commercially by companies such as Eaton (www.eaton.com; search query: gas liquid separators). Other alternative embodiments will operate without the presence of the fluid separator 34 and such embodiments are also within the scope of the present invention.

In certain embodiments, additional optional features are included in the system. These features are also illustrated in FIG. 2. For example, the fluid separator 34 is provided with an automatic dump port 40 and a level shut-off switch 38 whose function is to disengage the vacuum source (regenerative fan blower 32 in this embodiment) when the level of fluid rises to a pr)-determined level. Dump port 40 is then opened automatically to allow fluid to dump from the system 10. The fluid separator 34 may also be provided with an upper float valve 42 as a back-up means for disengaging the regenerative fan blower 32 when the fluid level reaches the top portion of the fluid separator 34. Also shown is a vent valve 44 disposed in vacuum conduit section 28. Vent valve 44 provides a means for manual control of the vacuum source when operating conditions require an adjustment of vacuum force on the screens S-1 and S-2. For example, if the cuttings become stalled on the screens S4 and S-2, there may be excessive vacuum force on the cuttings which holds them in place on the screens S-1 and S-2 and prevents the desired conveyance of the cuttings from the screens S-1 and S-2. In such a case, opening of vent valve 44 to reduce the vacuum force may allow the cuttings to resume conveyance from the screens S-1 and S-2, as desired. Additional safety valves 46 and 48, an in-line filter 50 and vacuum gauges 52 and 54 are provided in and/or adjacent to vacuum conduit section 33 near the regenerative fan blower 32 to provide additional manual control and to monitor the operation of the system 10.

To operate the system 10, the regenerative fan blower 32 is switched on and a vacuum force is pulled (as indicated by the solid arrows in FIG. 2) down through the screens S-1 and S-2, through the vacuum screen attachments 12a and 12b, through the vacuum conduits 14a, 14b, and 16, through the hydrostatic chamber 20, through the vacuum equalization tube 28, through vacuum conduit section 30, through the fluid separator 34 and through vacuum conduit section 33. Additionally, vacuum force is pulled through fluid dump port 26 and vent valve 44 as indicated by solid arrows at these locations. In certain embodiments, the area or diameter opening of fluid dump port 26 is adjustable and can be throttled as a means of adjusting the balance between the force of gravity acting on the hydrostatic head of fluid in the hydrostatic chamber 20 and the influx of air under vacuum into the system 10 through fluid dump port 26. During a normally functioning process, fluid is conveyed from the cuttings on the screens S-1 and S-2 through the first portions of the vacuum force pathway described above. However, most of the fluid does not travel past the hydrostatic chamber 20 because it collects inside the hydrostatic chamber 20 and in the vacuum equalization tube 28 to the point where the growing column of fluid forms a hydrostatic head with pressure sufficient to counteract the influx of air entering the system 10 through fluid dump port 26. The vacuum equalization tube functions to reduce the vacuum force near fluid dump port 26. After this balance between the force of inflow of air into dump port 26 under vacuum and the force of gravity acting on the hydrostatic head has been exceeded, fluid will be dumped from fluid dump port 26 until the column of fluid is reduced in height to the point where the force of gravity acting on the column is no longer sufficient to counteract the force of air flowing into the system 10 through fluid dump port 26. This cycle will repeat for as long as the vacuum is switched on and fluid is pulled through the system 10.

Fluid dumped from fluid port 26 is routed to the mud tanks (not shown) as indicated by the broken arrow in FIG. 2, using a conventional fluid conveyance system. As a result, there is no need for a large fluid holding tank as described above.

While most fluid being removed from drill cuttings will be dumped from fluid dump port 26 and thereafter conveyed to the mud tanks, the skilled person will appreciate that this mechanism will not be sufficient to remove all fluids, particularly when they exist in the vapor state. It is advantageous in certain embodiments to capture such fluids escaping from the hydrostatic chamber 20 via vacuum conduit section 30. Therefore, system 10 is provided with a fluid separator 34. When fluids accumulate in the fluid separator 34 to a pre-determined level, a level shut-off valve is automatically engaged and the regenerative fan blower is then shut off. In certain embodiments, this process is coupled to the opening of valve 40 to dump fluid from the fluid separator 34.

Certain alternative embodiments of system 10 are configured to automatically stop and re-start the regenerative fan blower 34 at regular intervals. When the vacuum force is disengaged, the compensating reflexive motion of the screens S-1 and S-2 may displace the drill cuttings from the screens S-1 and S-2 which may reduce clogging of the screens S-1 and S-2. As a result, this may also reduce the need for rig workers to regularly inspect and clear clogged shaker screens. In certain embodiments, methods of operating the system of the present invention include an automatic shut-off of the regenerative fan blower 34 at intervals ranging from about 10 to about 20 minutes for a period of about 10 to about 20 seconds, after which the regenerative fan blower 34 is re-started.

### Example 2

### Drill Fluid Recovery System with Primary Fluid Recovery Driven by an Air Distribution and Fluid Dump Assembly and Secondary Fluid Recovery Driven by a Hydrostatic Chamber

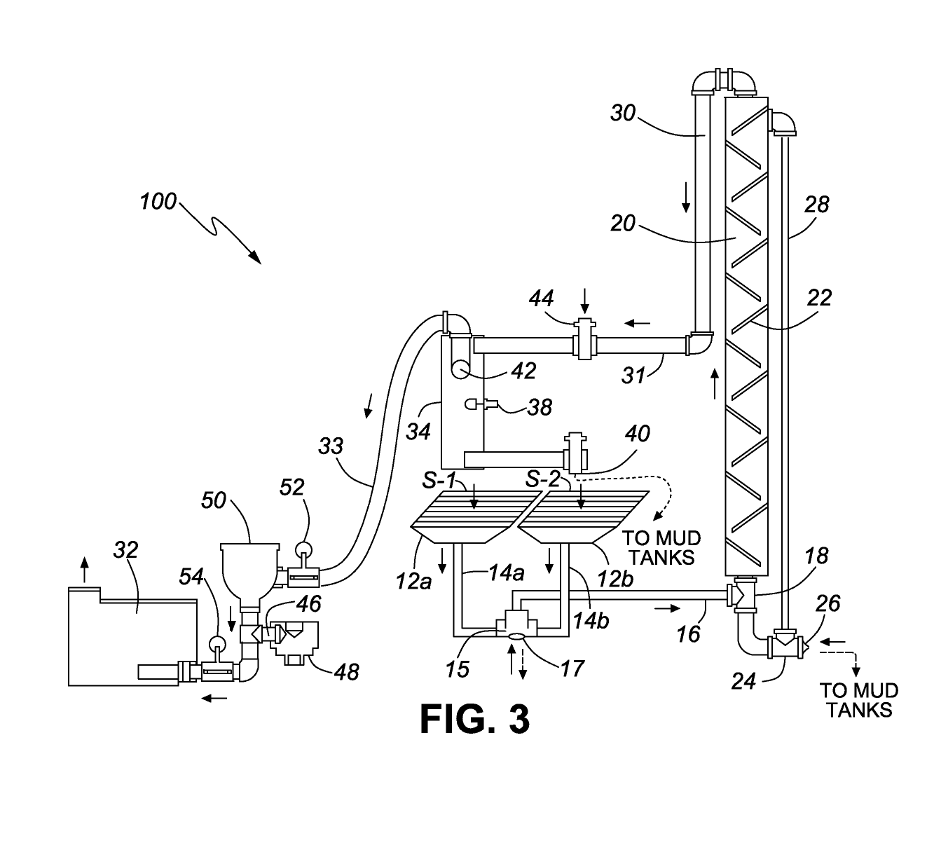

In accordance with another embodiment of the present invention and with reference to FIG. 3, there is shown another system 100 for recovering drilling fluid from drill cuttings. System 100 has many features similar to the features of the embodiment shown in FIG. 2 and therefore similar reference numerals are used in the ensuing description of operation of this system. The main difference between system 10 (FIG. 2) and system 100 (FIG. 3) is that system 100 is provided with a conduit connector unit which is herein described as the “air distribution and fluid dump assembly.” The air distribution and fluid dump assembly 15 is connected to vacuum conduits 14a and 14b and to vacuum conduit 16 which leads to the hydrostatic chamber 20. It is to be understood that the structure of the air distribution and fluid dump assembly 15 can be modified to include additional ports for additional conduits originating from additional shaker screens. The air distribution and fluid dump assembly 15 is provided with a fluid dump port 17 which faces downward from the main body of the air distribution and fluid dump assembly 15. Fluid dump port 17 may be provided with a means of adjusting the area or diameter of the port opening.

Making the opening of dump port 17 smaller will decrease the total force of the air flow entering the system 100 through the opening and vice versa. Therefore, an optimized dump port 17 will allow the force of gravity acting on the weight of the fluid passing over the opening to overcome the in-flow air pressure while allowing the fastest dump rate possible. If the opening is too big, the pressure of the in-flow air will counteract the gravity force acting on the fluid in the air distribution and fluid dump assembly 15 and prevent fluid from dumping. If the opening is too small, fluid will exit but at a slower rate which may not keep the same pace as the rate of fluid entry into air distribution and fluid dump assembly 15. As a result, most of the fluid will bypass the air distribution and fluid dump assembly 15 and continue toward the hydrostatic chamber 20.

During operation of system 100, fluid is drawn from the drill cuttings on the screens S-1 and S-2 as in the operation of system 10 (FIG. 2). However, instead of being conveyed directly to the hydrostatic chamber 20 via vacuum conduit 16 (as in system 10), it is routed into the air distribution and fluid dump assembly 15. When the system 100 is operating as intended with generally consistent vacuum force being applied to the undersides of the screens SC-1 and SC-2 and when the fluid dump port 17 has a substantially optimized diameter, fluid will enter the air distribution and fluid dump assembly 15 via vacuum conduits 14a and 14b and be consistently dumped out at fluid dump port 17. As noted above in the discussion of the process of fluid dumping from fluid dump port 26, to achieve dumping of fluid from fluid dump port 17 the force of gravity acting on the fluid moving through the air distribution and fluid dump assembly 15 above fluid dump port 17 should be greater than the force of air entering the air distribution and fluid dump assembly 15 which is induced by the vacuum force in the system 100. Therefore, it is advantageous in certain embodiments to provide a means for controlling the area or diameter of the opening of port 17. As noted above, if the area or diameter of the opening of port 17 is too large, excessive air pressure will enter the air distribution and fluid dump assembly 15 and act against the force of gravity on the weight of the fluid, preventing it from exiting through dump port 17.

On the other hand, if the area or diameter of the port 17 is designed or adjusted properly, the pressure exerted by aft flowing into the system via port 17 will be overtaken by the pressure provided by the force of gravity acting on the weight of the fluid above the opening and as a result, fluid will be dumped from port 17. Therefore, one particular embodiment of the system includes an air distribution and fluid dump assembly with an overall interior volume of about 12 to about 20 cubic inches having three vacuum conduit ports with diameters of about 2 to about 3 inches and a fluid dump port with an opening diameter of about 0.25 to 0.75 inches. This arrangement has been found to produce relatively consistent dumping of fluid through port 17 when a total vacuum force of about 195 to about 235 CFM (cubic feet per minute). This arrangement provides between about 4 to about 6 CFM of air flow through dump port 17 into the system 100. It is estimated that air enters the system at approximately the same rate through dump port 26 which is responsible for dumping fluid from the hydrostatic chamber 20 as described above. Additionally, about 22 to about 28 CFM of air enters the system 100 via vent valve 44.

Without being bound by any particular theory, it is believed that the collision of turbulent streams of fluid entering the air distribution and fluid dump assembly 15 from directionally opposed vacuum conduits 14a and 14b may provide the effect of slowing down the vacuum-induced fluid flow above dump port 17, thereby inducing the fluid to be overtaken by gravity to exit the system at port 17. Thus, in alternative embodiments employing conduits from three or more screens, it is advantageous to provide an air distribution and fluid dump assembly with opposed vacuum conduits (such as the arrangement shown in FIG. 3) to encourage the incidence of collisions of opposing streams of fluid.

It is estimated that during operation, for example at an air flow rate of about 195 to about 235 CFM, and without significant blockage of the screens by cuttings or other extraneous materials, about 80% of the fluid drawn from cuttings on the screens S-1 and S-2 will exit the system 100 at fluid dump port 17 when fluid dump port 17 is provided with an opening having a diameter of about 0.5 inches. The remaining fluid will continue to be conveyed by vacuum conduit 16 into the hydrostatic chamber 20. The hydrostatic chamber 20 then functions as described above for system 10, with the exception that fluid is expected to exit from fluid dump port 26 much less frequently than would be observed for system 10 because 80% of the total fluid conveyed from the cuttings has already exited the system at fluid dump port 17.

During blockage of the screen S-1 and/or screen S-2, less fluid is drawn into the system from the drill cuttings. As a result, less fluid flows into the air distribution and fluid dump assembly 15. It follows that the mass of fluid flowing above port 17 is less than it would be during optimal fluid recovery conditions. As a result, the balance between the gravity force on the fluid passing over port 17 and the force of the air intake at port 17 is disrupted and the air intake force prevents the reduced mass of fluid from dumping from port 17. In such cases, the majority of fluid would then be conveyed to the hydrostatic chamber 20 where it is then dumped more frequently via dump port 26. The remaining components of system 100 operate in a manner similar to their operation in the previously described operation of system 10. In such cases where blockages of the screens occurs, the blockages may be automatically resolved by the automatic vacuum shut-off mechanism described above, which may take advantage of the compensating reflexive motion of the screens to catapult cuttings of the screens. The manual valve 44 may also be used for this purpose.

### Example 3

### Drilling Fluid Recovery System with a Dynamic Fluid Reservoir and Vacuum Control with Fluid Level Sensing

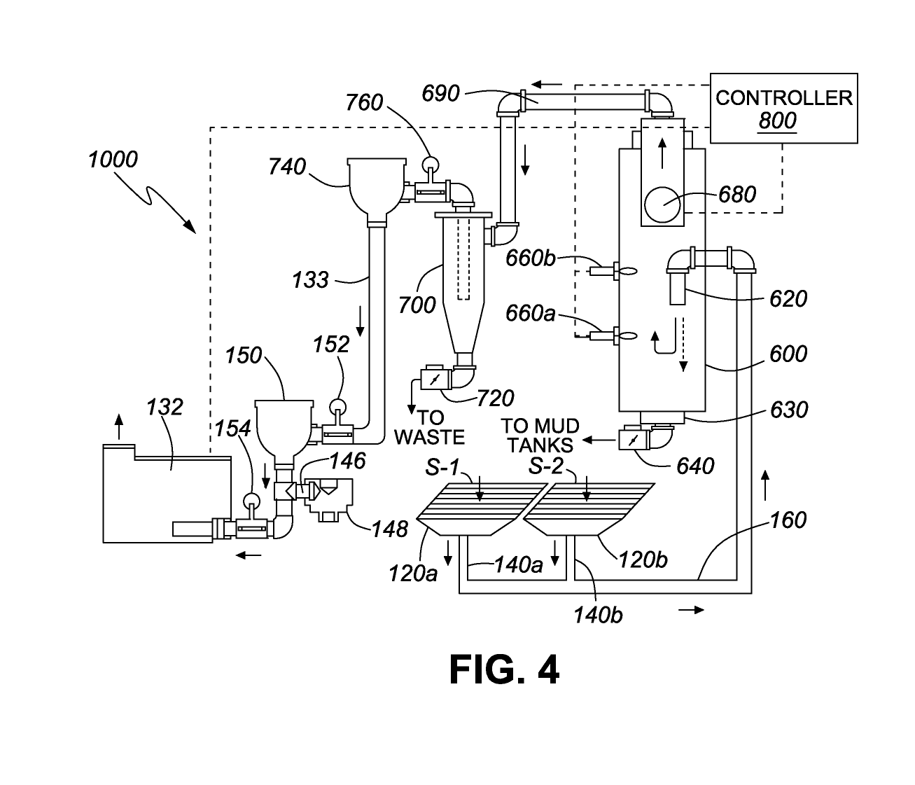

Referring now to FIG. 4, there is shown a system 1000 according to another embodiment of the present invention. In FIG. 4, components common to the previous embodiments are indicated by reference numerals in the 100 series. System 1000 is shown connected to two shaker screens S-1 and S-2 in a manner similar to that used in the previously discussed embodiments. Alternative embodiments include only a single connection to a single screen or more than two connections to more than two screens. These alternatives are within the scope of the invention.

The connections to the screens S-1 and S-2 are made with vacuum screen attachments 120a and 120b. Vacuum screen attachments 120a and 120b are connected to respective vacuum conduits 140a and 140b which join a common conduit 160 that leads directly to a fluid reservoir 600, terminating inside the fluid reservoir 600 in a down-spout 620 which is provided to send drilling fluid down to the bottom of the fluid reservoir 600. The reservoir has one or more fluid level sensors 660a and 660b in communication with a controller 800. Sensors 660a and 660b are triggered when the level of drilling fluid building up inside the fluid reservoir 600 reaches them (unless sensor 660a is manually or otherwise disabled, sensor 660b should not be reached by the top surface of fluid collecting in the reservoir. The locations of the sensors 660a and 660b along the interior vertical wall of the reservoir 600 are placed for delineation of convenient volumes of drilling fluid. The function of the sensors 660a and 660b Will be discussed in more detail hereinbelow when the function of the system is described in detail.

The reservoir 600 has a fluid dump port 630 at the bottom surface which communicates with a flapper valve 640 for dumping of drilling fluid into a conduit (not shown) for routing it back to the mud tanks where it is re-used in drilling operations. In one embodiment, the flapper valve 640 is a one-way valve having a passive valve flap that, under opening conditions, allows the one-way movement of fluid through the flapper valve.

A float valve 680 is provided at the top of the reservoir 600. If the sensors 660a and 660b fail. Float valve 680 provides a means for communicating a high fluid level to the controller 800 so that the vacuum can be shut off.

The reservoir 600 is in-line with the vacuum source (regenerative fan blower 132). A vacuum conduit 690 extends from the top of the reservoir 600 and leads to a cyclone vessel 700 whose function is to remove fluid from the air vacuum stream to conserve the filters 740 and 150. The fluid removed from the vacuum stream is dumped to waste from flapper valve 720. There is a vacuum gauge 760 upstream of filter 740.

The additional components of the system downstream from the cyclone are similar to the components shown in FIGS. 2 and 3. Additional safety valves 146 and 148, an in-line filter 150 and vacuum gauges 152 and 154 are provided in and/or adjacent to vacuum conduit section 133 near the regenerative fan blower 132 to provide additional manual control and to monitor the operation of the system 10.

During operation, air will be pulled (as shown by the solid arrows) by the regenerative fan blower 132 through the screens S-1 and S-2, through conduits 140 and 160 to the down-spout 620 inside the reservoir 600. The fluid reservoir is under vacuum pressure while the regenerative fan is running which overcomes the hydrostatic pressure of the fluid and which causes the flapper valve 640 to stay closed. This allows fluid to accumulate in the fluid reservoir 600 until the upper surface of the fluid rises in the reservoir and it reaches sensor 660a. As the fluid level hits sensor 660a, sensor 660a is triggered and sends instructions to the controller 800 (dotted line) to shut off the vacuum source 132. With the absence of vacuum, there is no force countering the force of gravity acting against the hydrostatic head of fluid in the reservoir 600 and thus the remaining force acts against the flapper valve 640, causing it to open and allowing the accumulated fluid to dump out of the reservoir.

The controller 800 includes a timer which is calibrated to provide enough time for the fluid to dump. When the period has elapsed, the controller is programmed to start again and another cycle will begin and end with another fluid dump. In this particular embodiment, sensor 660a is placed at a height in the reservoir such that the volume of fluid reaching it is 25 L. Sensor 660b likewise defines a volume of 50 L. If sensor 660a is manually disabled, the system will dump 50 L on each cycle. Alternative embodiments may be configured to hold and dump different volumes, depending on the requirements for various drilling fluid separations.

It is advantageous to provide two different dump volumes because different drilling fluids having different densities are used for different drilling operations. It may be advantageous to dump lower density drilling fluid in 50 L volumes and higher density drilling fluid dump in 25 L volumes. Other volumes may be used in alternative embodiments and can be defined by alternative sensor height placement.

### Concluding Remarks

In the description and claims, the terms “upstream” and “downstream” are used as a matter of convenience to identify positions of certain features. The term “downstream” indicates the direction of fluid and gas flow under vacuum source with the last downstream component of the system being the vacuum source. Likewise, the last “upstream” component of the system is the vacuum screen attachment.

Although the present invention has been described and illustrated with respect to preferred embodiments and preferred uses thereof, it is not to be so limited since modifications and changes can be made therein which are within the full, intended scope of the invention as understood by those skilled in the art.

1. A system for recovering used drilling fluid from drill cuttings being processed on a shaker screen, the system comprising:
a vacuum screen attachment operatively connected to the underside of the shaker screen, the vacuum screen attachment operatively connected to a vacuum source by a vacuum conduit;
a hydrostatic chamber located in the vacuum conduit downstream of the vacuum screen attachment, the hydrostatic chamber having a fluid dump port at or adjacent to its bottom surface;
a means for setting a limit of fluid accumulation in the hydrostatic chamber, wherein fluid dumps from the fluid dump port when the limit of fluid accumulation is reached; and
a conduit for conveying the fluid dumped from the fluid dump port to a storage tank.

2. The system of claim 1, wherein the means for setting the limit of fluid accumulation comprises:
one or more fluid level sensors configured to identify one or more specific levels of fluid inside the hydrostatic chamber;
a vacuum controller for running and shutting off the vacuum source, the controller in communication with the sensors and configured to stop the vacuum source when one of the one or more specific levels of fluid is reached; and
a valve connected to the fluid dump port and configured to prevent dumping of fluid from the fluid dump port when the vacuum source is running and further configured to allow dumping of fluid when the vacuum source is shut off.

3. The system of claim 2, wherein the sensors include a first fluid level sensor and a second fluid level sensor, each located within the hydrostatic chamber, wherein the first fluid level sensor is located above the second fluid level sensor.

4. The system of claim 2, wherein the valve is a passive flapper valve.

5. The system of claim 3, further comprising a float valve in the hydrostatic chamber above the first fluid level sensor, the float valve configured to shut off the vacuum source if either or both of the sensors fail and fluid reaches and activates the float valve.

6. The system of claim 1, further comprising a fluid separator located in the vacuum conduit between the hydrostatic chamber and the vacuum source, the fluid separator provided to prevent entry of fluid into the vacuum source.

7. The system of claim 6, wherein the fluid separator is a cyclone separator provided with a lower port for exit of waste fluid collected therein.

8. The system of claim 6, further comprising one or more filters located in the vacuum conduit between the fluid separator and the vacuum source.

9. The system of claim 1, wherein the hydrostatic chamber is cylindrical.

10. The system of claim 1, wherein the vacuum source is connected to the hydrostatic chamber at the top of the hydrostatic chamber.

11. The system of claim 1, wherein the vacuum source is a regenerative fan blower.

12. The system of claim 1, wherein the means for setting the limit of fluid accumulation in the hydrostatic chamber is provided by a vacuum equalization tube having a first connection to the interior of the hydrostatic chamber at or adjacent to the bottom of the hydrostatic chamber and a second connection to the interior of the hydrostatic chamber located above the first connection, wherein the fluid dump port allows entry of air into the hydrostatic chamber and into the vacuum equalization tube under force of the vacuum source and allows exit of fluid from the hydrostatic chamber and vacuum equalization tube induced by a reduction of vacuum force at the fluid dump port produced by the vacuum equalization tube and by the force of gravity acting on the hydrostatic head of the fluid in the hydrostatic chamber when the force of gravity on the hydrostatic head exceeds the force of air entering the system through the fluid dump port.

13. The system of claim 12, further comprising a second fluid dump port located in the vacuum conduit either upstream or downstream from the hydrostatic chamber.

14. The system of claim 13, wherein the second fluid dump port is located in the vacuum conduit between the vacuum screen attachment and the hydrostatic chamber, wherein the second fluid dump port allows entry of air into the vacuum conduit under force of the vacuum source and exit of fluid from the vacuum conduit through the second fluid dump port induced by the force of gravity acting on the weight of the fluid above the second fluid dump port.

15. The system of claim 14, wherein the second fluid dump port is located in a conduit connector unit, the connector unit having a connection to at least one vacuum screen attachment and a connection to the vacuum source.

16. The system of claim 15, wherein the conduit connector unit comprises two or more connections to two or more vacuum screen attachments.

17. The system of claim 13, wherein the second fluid dump port is provided with a choke mechanism for reducing the pressure of the air flow into the vacuum conduit under force provided by the vacuum source.

18. The system of claim 12, wherein the second connection of the vacuum equalization tube to the hydrostatic chamber is located adjacent the top of the hydrostatic chamber.

19. The system of claim 12, wherein the hydrostatic chamber is cylindrical.

20. The system of claim 12, wherein the inner sidewall of the hydrostatic chamber is provided with a series of downwardly angled baffles to provide resistance to upward movement of fluids under the force of vacuum from the vacuum source.

21. The system of claim 12, wherein the vacuum source is connected to the hydrostatic chamber at the top of the hydrostatic chamber.

22. The system of claim 12, further comprising a fluid separator located in the vacuum conduit between the hydrostatic chamber and the vacuum source, the fluid separator provided to prevent entry of fluid into the vacuum source.

23. The system of claim 22, further comprising a shut-off switch attached at an intermediate vertical position of the inner sidewall of the liquid separator, the shut-off switch for shutting off the vacuum source when the fluid level inside the fluid separator reaches the level of the shut-off switch.

24. The system of claim 23, further comprising a third fluid dump port located in the vacuum conduit downstream of the liquid separator, the third fluid dump port configured to dump fluid accumulating in the liquid separator when the shut-off switch is engaged and the vacuum system is shut off.

25. The system of claim 22, further comprising a vent valve located in the vacuum conduit between the hydrostatic chamber and the liquid separator.

26. The system of claim 12, further comprising a shut-off switch in electronic communication with the vacuum source and automatically programmed to shut off the vacuum source at pre-determined intervals for a pre-determined period of time for the purpose of displacing the drill cuttings from the shaker screen by compensating reflexive motion of the shaker screen.

27. The system of claim 12, wherein the vacuum source is a regenerative fan blower.

28. A method for recovering used drilling fluid from drill cuttings being processed on a shaker screen, the method comprising the steps of:
connecting a vacuum source to the underside of the shaker screen with a vacuum screen attachment, the vacuum source providing vacuum force to the underside of the shaker screen;
installing a hydrostatic chamber in the vacuum conduit between the vacuum screen attachment and the vacuum source;
providing a fluid dump port and valve in fluid communication with the hydrostatic chamber, the fluid dump port and valve allowing exit of fluid from the hydrostatic chamber induced by a reduction of vacuum force within the hydrostatic chamber and by the force of gravity acting on the hydrostatic head of the fluid in the hydrostatic chamber when the vacuum force is reduced; and
activating the vacuum source until a pre-determined level of fluid is contained in the hydrostatic chamber, wherein the pre-determined level of fluid causes the fluid to drain from the fluid dump port.

29. The method of claim 28, wherein the pre-determined level of fluid is identified by a sensor.

30. The method of claim 29, wherein the identification of the pre-determined level of fluid by the sensor shuts off the vacuum source.

31. The method of claim 28, wherein the pre-determined level of fluid is reached when the force of gravity acting on the hydrostatic head of the fluid exceeds the force of air entering the fluid dump port under vacuum provided by the vacuum source.

32. The method of claim 31, further comprising providing a second fluid dump port in the vacuum conduit either upstream or downstream from the hydrostatic chamber and recovering the fluid dumping from the second fluid dump port.

33. The method of claim 32, wherein the second fluid dump port is located in the vacuum conduit between the vacuum screen attachment and the hydrostatic chamber, the second fluid dump port allowing entry of air into the vacuum conduit under force of the vacuum source and exit of fluid from the vacuum conduit through the second fluid dump port induced by the force of gravity acting on the weight of the fluid above the second fluid dump port.

34. The method of claim 32, wherein the second fluid dump port is located in a conduit connector unit, the connector unit having a connection to at least one vacuum screen attachment and a connection to the vacuum source.

35. The method of claim 34, wherein the conduit connector unit comprises two or more connections to two or more vacuum screen attachments.

36. The method of claim 32, wherein the second fluid dump port is provided with a choke mechanism for reducing the pressure of the air flow into the vacuum conduit under force provided by the vacuum source.

37. The method of claim 28, wherein the inner sidewall of the hydrostatic chamber is provided with a series of downwardly angled baffles to provide resistance to upward movement of fluids under the force of vacuum from the vacuum source.

38. The method of claim 28, wherein the vacuum source is connected to the hydrostatic chamber at the top of the hydrostatic chamber.

39. The method of claim 28, wherein a fluid separator is provided in the vacuum conduit between the hydrostatic chamber and the vacuum source, the fluid separator provided to prevent entry of fluid into the vacuum source.

40. The method of claim 28, wherein the vacuum source is a regenerative fan blower.
